(19) United States
(12) Patent Application Publication
(10) Pub. No.: US 2022/0027449 A1
(43) Pub. Date: Jan. 27, 2022

(54) METHOD OF ALLOWING ACCESS TO COMPUTER APPLICATIONS

(71) Applicant: PASS2OPEN INC., Lumberton, TX (US)

(72) Inventors: Bradley D. Bennett, Lumberton, TX (US); Jigesh V. Vora, Houston, TX (US)

(21) Appl. No.: 17/384,427

(22) Filed: Jul. 23, 2021

Related U.S. Application Data
(60) Provisional application No. 63/055,664, filed on Jul. 23, 2020.

(51) Int. Cl. G06F 21/36; G06F 21/62

(52) U.S. Cl. CPC G06F 21/36; G06F 21/6218

(57) ABSTRACT

A method of allowing a computer application to be accessed by a user. The method can have the following steps: identifying a computer application, disabling access to the computer application, presenting one or more images to the user upon the user requesting to access the computer application, requiring an input action by the user based upon the presented image, and determining whether to allow the computer application to open based upon the user's input action.

### CROSS REFERENCE TO RELATED APPLICATION

The current application claims priority to and the benefit of co-pending U.S. Provisional Patent Application Ser. No.: 63/055,664 filed on Jul. 23, 2020, titled “METHOD OF ALLOWING ACCESS TO COMPUTER APPLICATIONS.” This application is incorporated herein in its entirety.

### FIELD

The present disclosure generally relates to a method of allowing a computer application to be accessed by a user.

### BACKGROUND

As electronic devices become more ubiquitous, parents are faced with the difficult task of limiting “screen time” for children. This becomes more difficult as often schoolwork needs to be completed on the same device which is used for recreation.

Similar issues may exist in the workplace, as employers may wish to limit access to social media and/or other applications at the workplace, during work hours, and/or on work devices.

The present disclosure provides an administrative method of controlling access to specific applications by a user.

### BRIEF DESCRIPTION OF THE DRAWINGS

The detailed description will be better understood in conjunction with the accompanying drawings as follows:

FIG. 1 depicts an administrative scree of the present method implemented by a computer.

FIG. 2 depicts an image presented to a user.

The embodiments of the present disclosure are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only, and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to a method of allowing a computer application to be accessed by a user.

While exemplary embodiments are described with respect to parents and/or teachers restricting access to computer applications for a child, it should be understood that any administrator can control access for any user.

The method of allowing a computer application to be accessed by a user can have the following steps: identifying a computer application, disabling access to the computer application, presenting one or more images to the user upon the user requesting to access the computer application, requiring an input action by the user based upon the presented image, and determining whether to allow the computer application to open based upon the user's input action.

Computer application as used herein refers to any program operable on a computer, laptop, tablet computer, smart phone, and the like. Exemplary applications may include social media applications, games, or chatting applications. The method can be implemented via an application or process running on the computer, laptop, tablet computer, smart phone, and the like. In embodiments, the method can be implemented via a cloud application or process which is not locally stored on the computer, laptop, tablet computer, smart phone, and the like.

Users can log into a cloud based account which then restricts the opening of a computer application.

Ideally the background application or process is not one that the user can start and stop and can be running in the background without the user able to affect the background application or process.

In embodiments, the computer application can be one from a preconfigured list, or an administrator can identify the computer application. For example, a preconfigured list of games and social media applications can be included in the configuration of the background application or process which implements the method. In other embodiments, an administrator (such as a teacher or parent) can determine apps specific to the user's device.

One or more images can be presented to the user upon the user requesting to access a computer application (i.e. a game or a social media application). The images can be preconfigured or require the administrator to provide the image presented to the user. The image can contain questions, math problems, logic problems, or any image requiring an input and response from the user.

In embodiments wherein the image comprises one or more questions, the user must answer via the input action. The input action may be touching an appropriate area of the screen, typing in a response, clicking on a button, or any other computer input known to persons having ordinary skill in the art. In embodiments, the input action may simply be the act of viewing or reading the presented image for a period of time.

In embodiments, one or more questions is selected from a curriculum appropriate to the user's age. For example, if the method is implemented on a high school student's phone, educational questions at a specific grade level can be presented. In embodiments, the specific curriculum studied by the user at the user's school can be used to generate the content of the image presented to the user.

Unless the user correctly navigates the presented image, the computer application is not allowed to be opened for the user.

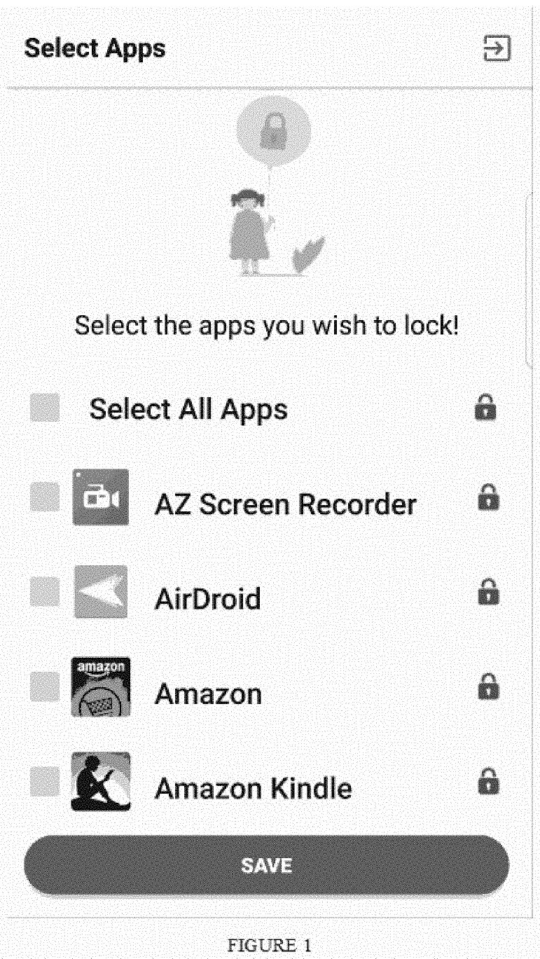

Turning now to the Figures, FIG. 1 depicts an administrative screen of the present method implemented by a computer.

Here an administrative user, i.e. a parent or a supervisor of an employee, can choose which applications have restricted usage and are subject to the disclosed method.

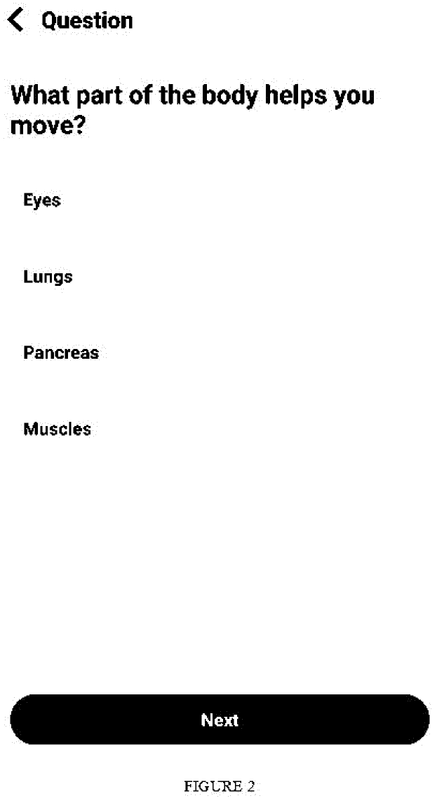

FIG. 2 depicts an image presented to a user.

In this embodiment, the user must answer a question in order to be allowed to access a specific application. This image would be presented to the user upon the user's attempt to access a specific application that is restricted. The list of restricted applications can be selected by an administrator as represented in FIG. 1.

In the image shown, the user would have to click the appropriate answer with an input device appropriate to the device being used. A mouse can be used to click the radio button, or a tap may be used for a touch screen.

While the present disclosure emphasizes the presented embodiments and Figures, it should be understood that within the scope of the appended claims, the disclosure might be embodied other than as specifically enabled herein

What is claimed is:

1. A method of allowing access to a computer application by a user, comprising:
a. identifying a computer application;
b. disabling access to the computer application;
c. presenting one or more images to the user upon the user requesting to access the computer application;
d. requiring an input action by the user based upon the presented image; and
e. determining whether to allow the computer application to open based upon the user's input action.

2. The method of claim 1, further comprising providing an administrator to identify the computer application.

3. The method of claim 1, further comprising providing an administrator to provide the one or more images presented to the user.

4. The method of claim 1, wherein the one or more images presented to the user comprises one or more questions requiring the user to answer via the input action.

5. The method of claim 4, wherein the one or more questions is selected from a curriculum appropriate to the user's age.

6. The method of claim 4, wherein the one or more questions is selected from a curriculum implemented at the user's school.

7. The method of claim 3, wherein the one or more images presented to the user comprises one or more questions requiring the user to answer via the input action.

8. The method of claim 5, wherein the one or more questions is selected from a curriculum implemented at the user's school.

9. The method of claim 6, wherein the one or more questions is selected from a curriculum appropriate to the user's age.

10. A computer implemented method of allowing access to a computer application by a user, comprising an application or a process which runs on a computer with computer instructions instructing a processor to implement the steps of:
a. identifying a computer application;
b. disabling access to the computer application;
c. presenting one or more images to the user upon the user requesting to access the computer application;
d. requiring an input action by the user based upon the presented image; and
e. determining whether to allow the computer application to open based upon the user's input action.

11. A computer implemented method of allowing access to a computer application by a user, comprising an application or a process which runs on a computer with computer instructions instructing a processor to implement the steps of:
a. identifying a computer application;
b. disabling access to the computer application;
c. presenting one or more images to the user upon the user requesting to access the computer application;
d. determining whether to allow the computer application to open based upon a user's input action.
